(19) United States
(12) Patent Application Publication
(10) Pub. No.: US 2022/0126929 A1
(43) Pub. Date: Apr. 28, 2022

(54) Tailgate Panel

(71) Applicant: AL Offroad Products LLC, Greenville, TX (US)

(72) Inventor: J. Scott PHILLIPS, Greenville, TX (US)

(21) Appl. No.: 17/492,215

(22) Filed: Oct. 1, 2021

Related U.S. Application Data
(60) Provisional application No. 63/105,017, filed on Oct. 23, 2020.

(51) Int. Cl. B62D 33/027; B60N 3/10; B60N 3/00

(52) U.S. Cl. CPC B62D 33/0273; B60N 3/001; B60N 3/101

(57) ABSTRACT

A system and method for a tailgate panel and modification. The tailgate panel has holes for coupling to a tailgate. The tailgate panel further includes a cup holder void and a cup holder coupled within the cup holder void. The panel is installed on a tailgate. The tailgate panel converts a previously unusable tailgate into a substantially planar and usable space.

### PRIORITY

The present invention claims priority to Provisional Application No. 63/105,017 filed Oct. 23, 2020, the entirety of which is hereby incorporated by reference.

### BACKGROUND OF THE INVENTION

### Technical Field

The present invention relates to a system and method for modifying a tailgate.

### Description of Related Art

Vehicles, such as trucks, often have tailgates. However, the tailgates are generally non-planar and unusable. Consequently, there is a need to modify existing tailgates.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective of a tailgate in one embodiment;

FIG. 2 is a perspective of a panel in one embodiment;

FIG. 3 is a perspective of a panel with a cup holder in one embodiment;

FIG. 4 is a perspective view of an installed cup holder in one embodiment;

FIG. 5 is a perspective of a tailgate with a tailgate panel removed in one embodiment;

FIG. 6 is a perspective view of a tailgate with a panel installed in one embodiment;

FIG. 7 is a perspective of a tailgate with a panel installed in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

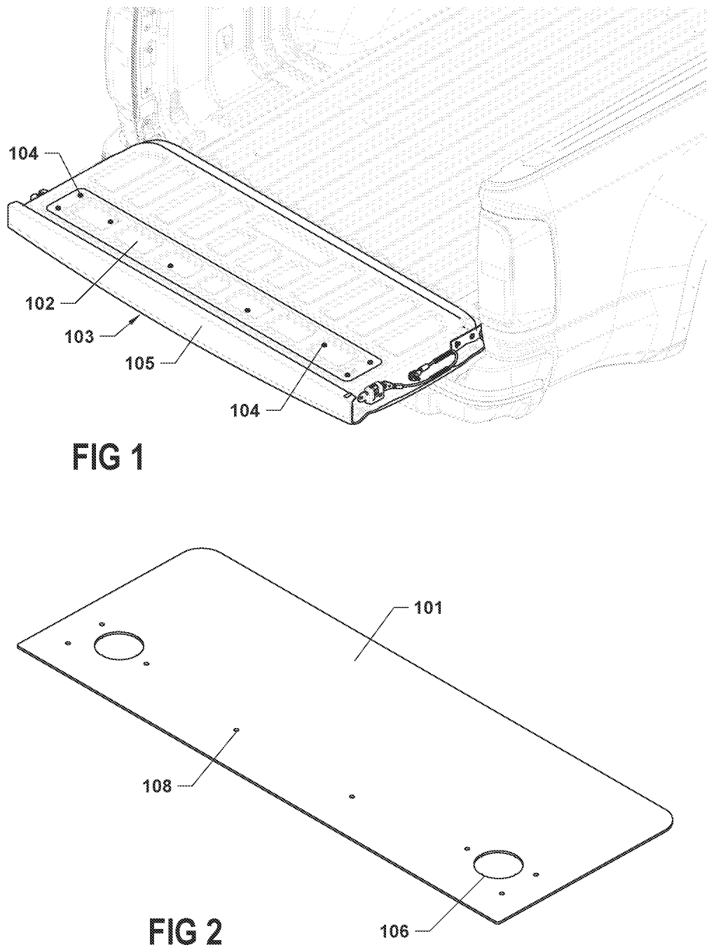

FIG. 1 is a perspective of a tailgate in one embodiment. As can be seen, the non-planar curves and contours of the tailgate 103 make it difficult to use the tailgate 103 for virtually anything. Items, such as a cup, will tip over due to the curves and groves of the top surface of the opened tailgate 103.

FIG. 2 is a perspective of a panel in one embodiment. The panel 101 can be placed such that the panel 101 is located atop the top facing open tailgate 103. A panel 101 converts an unusable top surface of a tailgate 103 into a usable surface.

The panel 101 can comprise virtually any material. It can comprise metal, plastic, wood, rubber, and combinations thereof. The thickness of the panel 101 can vary as well depending upon the desired application. In one embodiment the panels are 5051 aluminum plates. The panels can range in thickness depending upon application. As an example, small truck panels can have a thickness of ⅛ of an inch and larger panels can comprise 3/16 of an inch. The panels can be manufactured via any method or device known in the art. In one embodiment they are laser cut from plate sheets. They are then deburred and powder coated, in one embodiment.

As shown the panel 101 is substantially planar. The dimensions of the panel 101 can vary depending upon the application and the size of the tailgate 103 that it is modifying. For example, a Toyota Tacoma has a tailgate 103 with dimensions which vary from a Ford F-150. The panel 101 can be used with any tailgate. This includes a tailgate on trucks, sport utility vehicles, all terrain vehicles, side-by-sides, etc. The panel 101 converts an unusable tailgate 103 surface into a usable space.

As shown the panel 101 comprises at least one coupler void 108. As depicted there is a plurality of coupler voids 108. As shown there is a plurality of coupler voids 108 spaced along the outer periphery of the panel 101. In one embodiment at least one coupler void 108 is completely surrounded by material in the panel 101. In other embodiments all of the coupler voids 108 are completely surrounded by material in the panel 101. The coupler voids 108 are holes or voids through which a coupler 104 can be inserted. In one embodiment the coupler voids 108 align with similar voids on the tailgate 103. In one embodiment, the number and spacing of the coupler voids 108 is dependent upon the voids located on the tailgate 103.

As shown, the panel 101 further comprises a cup holder void 106. A cup holder void 106 is a void in the panel 101 into which a cup holder or cup can be inserted. As shown the void 106 is completely surrounded by material. As shown, the cup holder void 106 is a void, or absence of material, in the panel 101. In one embodiment, and as depicted, the cup holder void 106 is circular. In one embodiment the cup holder void 106 is laser cut.

As depicted in FIG. 2, the panel 101 has various cutouts 109 along its edge. This is to provide a custom and snug fit adjacent the tailgate 103. Accordingly, in one embodiment the panel 101 is shaped substantially similar to the tailgate panel 102 that it is replacing. The cutouts 109 are voids in the outer perimeter of the panel which can accommodate features from the vehicle or tailgate and allow a snug fit.

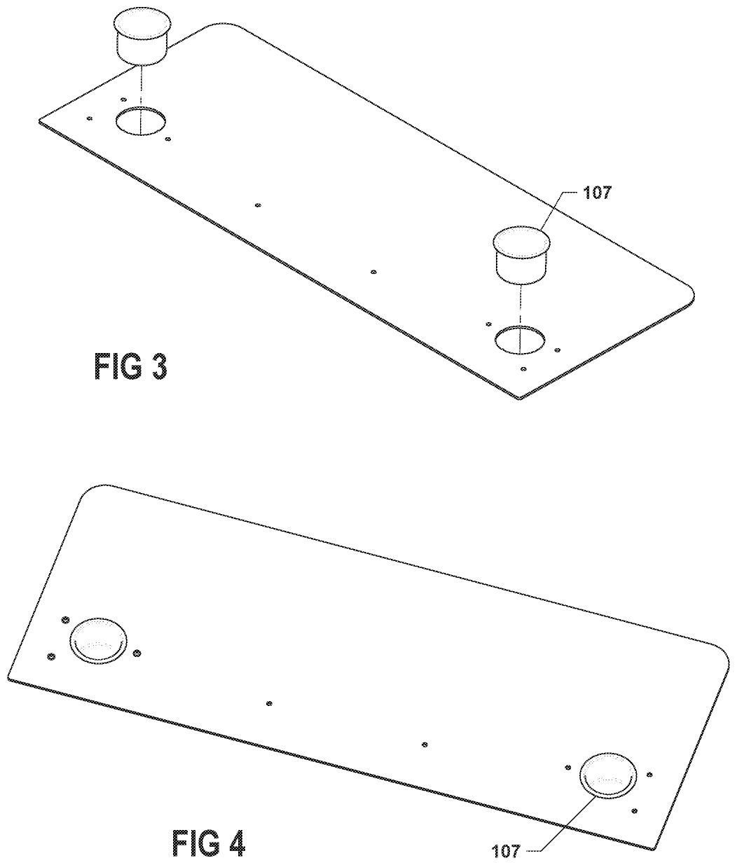

FIG. 3 is a perspective of a panel with a cup holder in one embodiment. In one embodiment an insert couples with the cup holder void. The insert couples with the void to provide a surface, container, or the like, to store an object. In one embodiment the insert comprises a cup holder 107. While one embodiment will be discussed wherein the insert is a cup holder 107, this is for illustrative purposes only and should not be deemed limiting.

In one embodiment the cup holder 107 is separate and removable from the panel 101. In other embodiments, however, the cup holder 107 is not removably coupled from the panel 101 but is, for example, integrally made. The cup holder 107 can comprise virtually any cup holder known in the art. In one embodiment the cup holder 107 is rubber or plastic. The cup holder 107 can couple with the cup holder void 106 via any method or device known in the art. In one embodiment the cup holder 107 couples to the cup holder void 106 via friction. In other embodiments the insert couples to the panel 101 via couplers such as screws, bolts, etc.

FIG. 4 is a perspective view of an installed cup holder in one embodiment. In this embodiment the cup holder 107 is essentially flush with the panel 101. Having the cup holder 107 essentially flush with the panel 101 allows objects to rest or sit upon the panel, including at the location of the cup holder 107, when there is no cup present. However, this embodiment is for illustrative purposes only and should not be deemed limiting. In other embodiments the cup holder 107 extends outwardly beyond the panel 101.

A method of installing a panel 101 will be described in reference to one embodiment. As noted above, however, tailgates vary so this description of installation is for one type of tailgate and should not be deemed limiting.

Turing back to FIG. 1, FIG. 1 shows a tailgate 103 which includes a tailgate skin 102. As shown the tailgate skin 102 is non-planar and has many ribs along its length. The ribs, or curves, are what prevent the tailgate skin 102 from being a usable surface. The ribs also make sitting upon the tailgate skin 102 uncomfortable.

The tailgate 103 depicted in FIG. 1 has a plurality of couplers 104 which affix the tailgate skin 102 to the tailgate 103. The couplers 104 can comprise any fastener which attach or fasten an object. This can include bolts, screws, etc.

The tailgate 103 depicted in FIG. 1 also has a top cover 105. The tailgate skin 102 slides under the top cover 105 or lip. Not all tailgates will have a top cover 105.

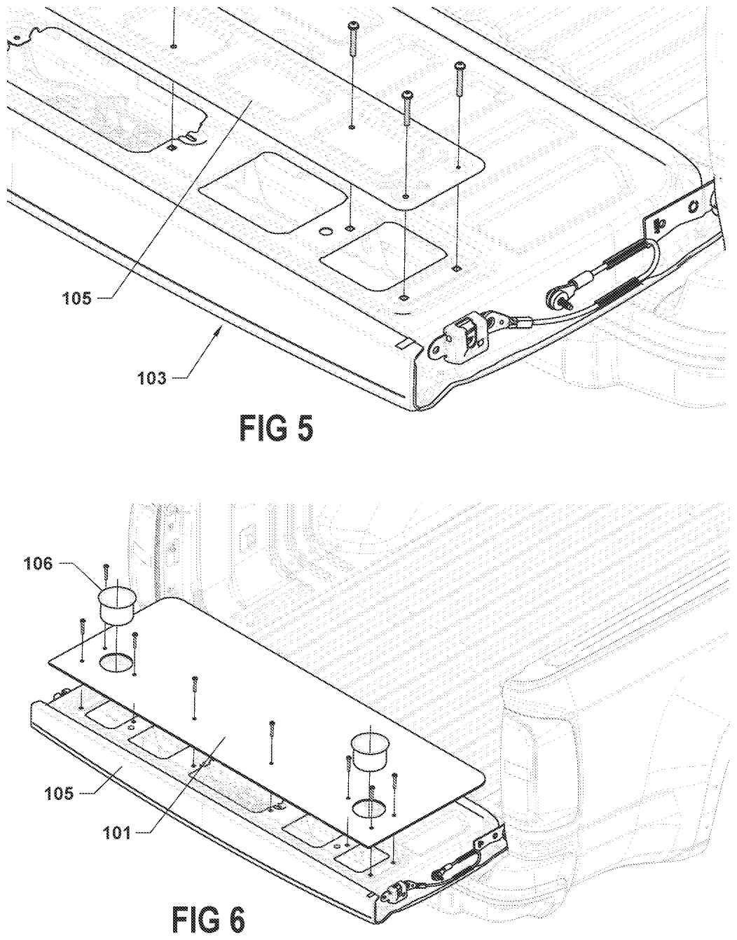

Turning now to FIG. 5, FIG. 5 is a perspective of a tailgate with a tailgate skin removed in one embodiment. As can be seen, the support structure of the tailgate 103 is visible with the skin removed.

Turning to FIG. 6, FIG. 6 is a perspective view of a tailgate with a panel installed in one embodiment. The panel 101 has been slid to be under the top cover 105. Thereafter, the couplers 104 are replaced. The total installation, in some embodiments, takes less than 15 minutes. In one embodiment the original tailgate top cover 105 is utilized. Thus, the original equipment manufactured (“OEM”) tailgate top cover is utilized. In other embodiments a new separate piece replaces the top cover 105.

The resulting tailgate 103 in FIG. 6 shows a substantially planar tailgate 103. The bumpy and unusable surface of the prior tailgate skin has been removed and replaced with a substantially planar surface. This substantially planar surface offers a usable space. Due to the height of the tailgate 103, the panel 101 is located at a height that is suitable for working and/or seating.

Tailgates are located at a height that offers a workspace for the user. However, as previously noted, previous bumpy tailgate skins offered a surface which was unworkable. The substantially flat and planar surface of the panel 101 offers a superior workspace. A user can set tools or objects upon the panel 101 without having them fall due to the bumpy surface. Further, the planar panel 101 is more comfortable to sit.

As shown, in some embodiments the panel 101 comprises cup holders 107. Cup holders 107 offer a safe and secure location to store a drink without fear of it tipping or getting knocked down. Thus, the cup holder 107 secures the drink in a desired location. As noted, in one embodiment the cup holders 107 comprises a circular cross-section. Virtually any number of cup holders can be utilized. There can be a single cup holder, or multiple cup-holders as shown. In one embodiment the system comprises a cup holder covering. A cup holder covering is a cup holder insert which has a top. Thus, rather than having a cup holder, the cup holder covering provides a flat planar surface which extends over the cup holder void. This allows users who do not want a cup holder, but instead want a flat surface, to convert the cup holder to a flat planar surface without a hole for a cup holder.

As previously noted, users often work at or sit upon a tailgate. Having the ability to store a drink at a location where it will not spill or get accidentally knocked over is a significant advantage. Whether the user is sitting upon the tailgate, or working on or around the tailgate, a cup holder 107 provides the user an opportunity and location to safety and securely store a beverage.

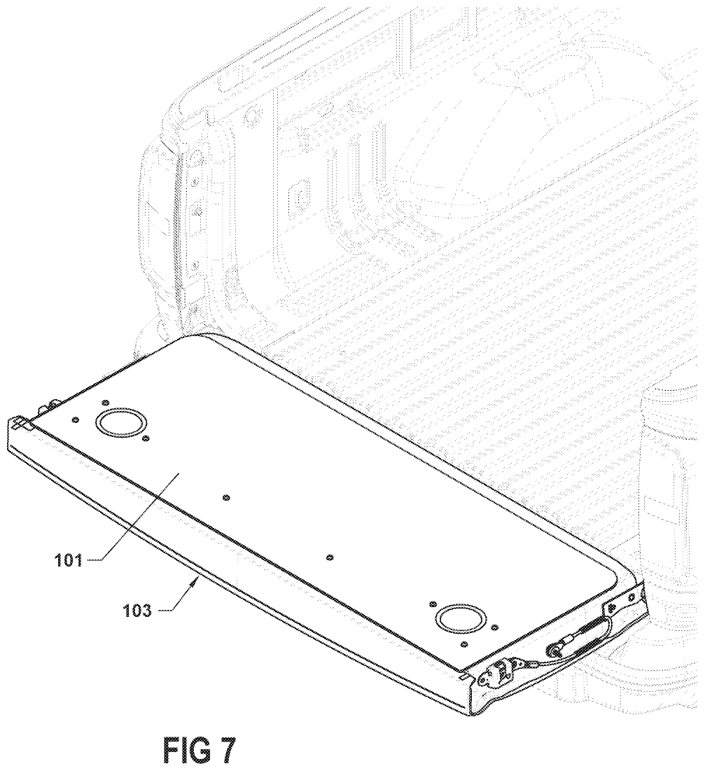

FIG. 7 is a perspective of a tailgate with a panel installed in one embodiment. As shown the user has placed a beverage in the cup holder. The user also has placed a stove on the other portion of the panel 101. This illustrates the usability and versatility of the panel 101. The panel 101 converts a previously unusable space into a usable table complete with, in some embodiments, a cup holder.

While the figures show a panel with two cup holders 107, this is for illustrative purposes only and should not be deemed limiting. In other embodiments, for example, the panel 101 will not have any cup holders. Instead, the user simply desires a flat planar surface. In other embodiments the panel 101 will have only a single cup holder, whereas in other embodiments, and as depicted, the panel 101 will have more than two cup holders. The number of cup holders 107 will be dependent upon the users desired configuration.

Additionally, the placement of the cup holders can vary. In one embodiment one cup holder is placed on each end of the panel 101, as depicted. In other embodiments, however, two cup holders are placed adjacent a single end. As with the number of cup holders, this is dependent upon the user's desired configuration.

While a circular cup holder has been shown, this is for illustrative purposes only and should not be deemed limiting. For example, in some embodiments a square or rectangular void will be utilized that can house either a cup or a tool or other product. Furthermore, as noted above, the insert which couples with the cup holder void 106, can be a cup holder 107 but can also comprise other inserts. The insert can have an open top, like the cup holder 107, or it can have a closed top, such as a cooler or toolbox. In one embodiment the insert comprises a lid which can be opened or closed. As an example, the void may be sized to house a jack or other tools. The insert is sized to fit within the void and house the desired item. As noted, the insert can comprise a lid or other locking mechanism to lock its contents. In one embodiment the lid is flush, or approximately flush, with the surrounding panel. In such embodiments, the lid of the insert can close such that the lid is flush. Thus, the insert provides an opportunity to house other items such as a jack, tool, personal belongings, etc.

While the invention has been particularly shown and described with reference to a preferred embodiment, it will be understood by those skilled in the art that various changes in form and detail may be made therein without departing from the spirit and scope of the invention.

What is claimed is:

1. A system for a tailgate panel, said system comprising:
a panel comprising holes for receiving couplers, and further comprising a cup holder void.

2. The system of claim 1 wherein said panel is installed on a tailgate.

3. The system of claim 2 wherein said tailgate comprises a top cover, and wherein said panel is installed below said top cover.

4. The system of claim 1 wherein said panel comprises aluminum.

5. The system of claim 1 further comprising at least one cup holder.

6. The system of claim 1 wherein said tailgate is on a truck.

7. The system of claim 6 wherein said truck is a Toyota Tacoma.

8. The system of claim 6 wherein said truck is a Ford.

9. The system of claim 3 wherein said tailgate is on an all-terrain vehicle.

10. The system of claim 1 wherein said tailgate panel replaces the OEM panel.

11. The system of claim 1 wherein said tailgate panel comprises two cup holder voids.

12. The system of claim 1 wherein said panel further comprises an insert which couples with said cup holder void.

13. The system of claim 12 wherein said insert comprises a lid.

14. The system of claim 12 wherein said insert comprises a cup holder.

15. The system of claim 12 wherein said insert is removable.
